(19) United States
(12) Patent Application Publication
(10) Pub. No.: US 2015/0089902 A1
(43) Pub. Date: Apr. 2, 2015

(54) METHOD OF MAKING A MAGNETIC STRUCTURE

(71) Applicant: Intercontinental Great Brands LLC, East Hanover, NJ (US)

(72) Inventors: Kerri Clark, Whippany, NJ (US); Maximiliano Rodriguez, East Hanover, NJ (US)

(21) Appl. No.: 14/397,911

(22) PCT Filed: May 15, 2013
(86) PCT No.: PCT/US2013/041100

§ 371 Date: Oct. 30, 2014

Related U.S. Application Data
(60) Provisional application No. 61/651,224, filed on May 24, 2012.

(51) Int. Cl. H01F 41/14; H01F 1/10; B65B 51/08

(52) U.S. Cl. CPC H01F 41/14; B65B 51/08; H01F 1/10
USPC 53/416; 427/547

(57) ABSTRACT

A method is provided for making a magnetic structure. The method includes forming a composition of magnetizable ferrites in a carrier on a substrate at a first location. The method further includes magnetizing the composition on the substrate at a second location different from the first location. More specifically, the substrate may be formed into a packaging housing at the second location and filled with consumable products.

### CROSS REFERENCE TO RELATED APPLICATIONS

This application claims priority to U.S. Provisional Patent Application No. 61/651,224 filed on May 24, 2012, the contents of which is incorporated herein by reference in its entirety.

### FIELD OF THE INVENTION

The present invention relates generally to a process for forming a magnetic structure and, more particularly, to a process for forming a package including a magnetic closure.

### BACKGROUND OF THE INVENTION

The formation of magnetizable material into a flexible structure as well as the subsequent magnetization of that structure into a permanent magnet is well known.

U.S. Pat. No. 7,128,798 describes the preparation of magnetic material where a ferrite material is mixed with a suitable polymeric binder or carrier into a uniform mixture. This mixture is formed by extrusion into a sheet or strip which can be magnetized by exposure to a magnetic field in a manner such as that described in U.S. Pat. No. 7,501,921.

As further described in the above-referenced patents, the magnetizable material which includes the ferrite materials within the polymeric binder is extruded with a hot melt extruder. The '921 patent describes that a magnetizing field may be applied to the composition when it is in a fluid condition. This allows movement of the ferrite materials within the binder resulting in alignment of the ferrite materials and an associated increase in the strength of the magnetic field of the magnet.

Additionally, it is known from commonly assigned International Application Publication Nos. WO 2012/057961, published May 3, 2012, and WO 2012/058413, published May 3, 2012, which are incorporated herein by reference for all purposes, that such magnetic materials may be applied to packaging substrates which are subsequently formed into a package for accommodation of confectionery products, for example, gum sticks or slabs. The magnetic material deposited on the packaging substrate can effectively serve as a re-openable magnetic closure for such package.

In order to construct a package for confectionery products having a magnetic closure, it is necessary to deposit the magnetic material on the packaging substrate and thereafter form the substrate into a confectionery product package and fill the package with the confectionery products.

Thus, at least two distinct processes are employed in forming the confectionery product package having a magnetic closure. First, the ferrite material is mixed with the polymeric binder into a magnetizable composition and the magnetizable material is extruded using the hot melt extruder onto the packaging substrate. Second, the packaging substrate is formed into a package housing and filled with the confectionery product.

It is desirable to provide an effective process which forms a confectionery package with magnetic closure.

### SUMMARY OF THE INVENTION

The present invention provides a method of making a magnetic structure. The method comprises forming a composition of magnetizable ferrites in a carrier on a substrate at a first location. Thereafter, the composition on the substrate is magnetized at a second location different from the first location.

The formed composition is transported from the first location to the second location.

The composition may be deposited onto packaging substrates, more preferably by extrusion. Thereafter, the packaging substrates can be transported from the first location to the second location.

The present invention also provides a method for forming a package for consumable products where the package has a magnetic closure. The method includes depositing, at a first location, a magnetizable composition on a packaging substrate. At a second location, different from the first location, the composition on the substrate is exposed to magnetization. Thereafter, the substrate is formed into a package housing and filled with consumable products.

### BRIEF DESCRIPTION OF THE DRAWINGS

FIG. 1 is a perspective showing of an embodiment of the package of the present invention for accommodating gum slabs.

FIG. 2 is an end elevational showing of the package of FIG. 1 in the closed condition.

FIG. 3 shows a flat paperboard blank used to form a package of the present invention.

FIG. 4 is a schematic representation of the steps employed in the method of the present invention.

FIGS. 5 and 6 show further steps of the method of forming a package of the present invention.

### DETAILED DESCRIPTION OF THE PREFERRED EMBODIMENT

The present invention provides a method of forming a package assembly having a magnetic closure. The magnetic closure of the present invention is a reopenable closure which allows the package to be opened and closed repeatedly to access the contents of the package, which in the present invention are confectionery products such as gum slabs or sticks. These gum slabs or sticks may optionally include individual wrappers thereover.

One particular magnetic material used to form a reopenable closure for the package assembly of the present invention may include materials having magnetic and/or magnetizable properties including, but not limited to, ferromagnetic materials which may include magnetic or magnetizable elements such as ferrite which are incorporated into a binding material or carrier. The carrier material, including the ferrites, may be formed into a composition strip which may be placed on the package to be formed as the closure.

As will be described in further detail hereinbelow, the magnetizable material may preferably be directly deposited on the packaging substrate. The carrier material may include a wide variety of materials, some of which have adhesive properties, so that the magnetic material may be applied to the packaging substrate, either subsequently or directly during formation. The preferred materials used as an adhesive carrier may include polyolefin and EVA. The magnetic material may be subsequently magnetized such that two such strips of material are mutually magnetically attracted so that when they are placed on the package housing they function as a reopenable magnetic closure.

The technique for forming the magnetic composition, applying the magnetic composition to a packaging substrate and subsequently magnetizing the magnetic material to function as an effective reopenable closure, as well as a preferred package assembly using the magnetic closure of the present invention, is more fully shown and described in the above incorporated International Application Publication Nos. WO 2012/057961, published May 3, 2012 and WO 2012/058413, published May 3, 2012.

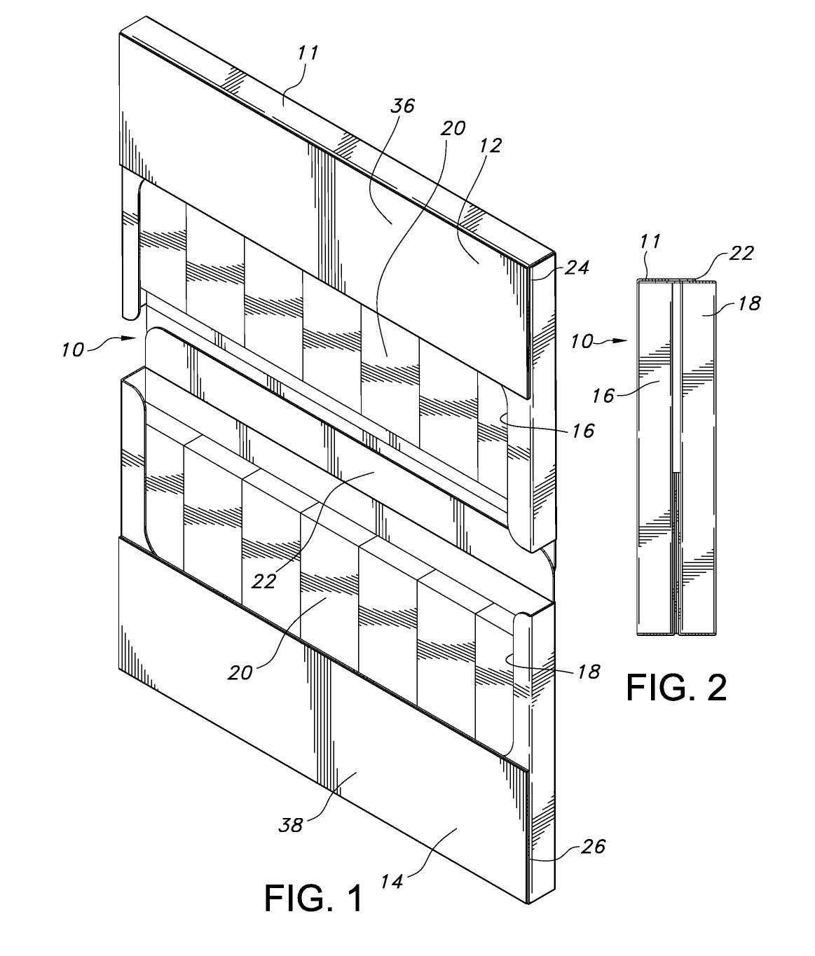

Referring now to FIGS. 1-3, it can be seen that a preferred package assembly of the present invention includes a pair of compartments arranged in book-like configuration where the package may be opened and closed about either side of a hinge member. The package is releasably maintained in the closed position by use of magnetic materials which are applied to the compartments on both sides of the hinge member.

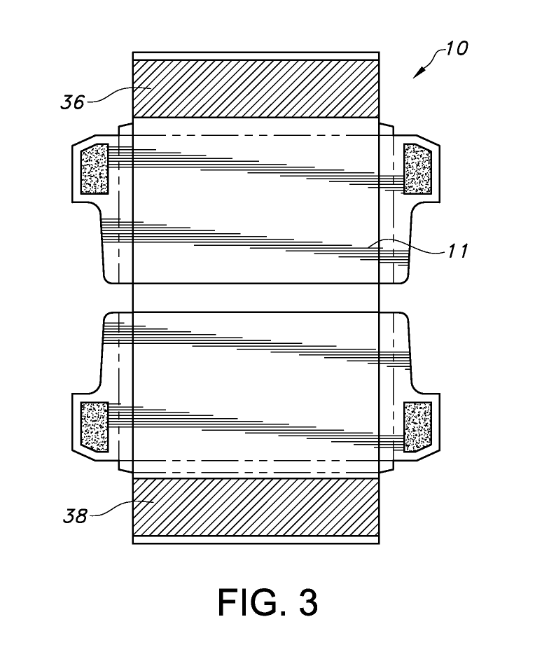

The package 10 of the present invention includes a package housing 11 which is generally formed of paperboard material folded from a flat blank (FIG. 3). While paperboard is the preferred material, other well known materials and combinations thereof may also be employed. The package 10 may be formed from a single flat paperboard blank or a pair of paperboard blanks secured to one another.

The paperboard blank or blanks are arranged into configurations shown in FIG. 1 to form a pair of compartments 12 and 14. Each compartment forms respectively product accommodating pockets 16 and 18 which accommodate a plurality of gum slabs 20 in side-by-side by upright array. Each compartment is separated by a foldable hinge 22 about which the package 10 can be opened and closed. The front walls 24 and 26 of compartments 12 and 14 may include the magnetic material which forms the reopenable closure.

The magnetic material forming the closure is applied to the front walls of the compartments as strips 36 and 38, respectively. Preferably, the strips are formed by hot melt extrusion of the ferrite materials within the carrier. More preferably, the strips can be extruded directly on the front walls of the compartments when the package is in a flat configuration. However, it is contemplated that the strips may be formed separately and then applied to a substrate.

As described in the above referenced '790 and '921 patents, the magnetic material used to form the strips includes preferably ferrite materials mixed with a polymeric carrier. Once the carrier is solidified, the ferrites are fixed within the carrier. The magnetic composition is magnetized so as to effectively function as a reopenable closure.

The present invention contemplates the ability to separate into two discrete processes, the formation of the magnetic composition on the substrate and the subsequent formation of the substrate into a package and the filling of the package with confectionery products such as gum sticks or slabs.

Since the formation of the magnetic composition is preferably by a hot melt extrusion process, more typically done at a facility, such as a molding, extruding, printing or converting facility, and as the formation and filling of the package assembly is done at a food handling facility, the present invention provides the ability to separate these two functions between two distinct locations. Where the extrusion is done at a separate location from the formation and filling location, it is recognized that the magnetic composition, applied to the substrate, must be transported to the food handling location.

It has been found that it is difficult to efficiently collect for transportation a plurality of magnetic compositions on a substrate where the compositions are magnetized. Thus, the present invention not only contemplates the separation of the formation of the magnetic compositions from the package forming and filling, but also contemplates separating the formation of the magnetic composition on a substrate from the further magnetization of the magnetic composition.

The present invention contemplates in its broad aspect accomplishing the present method in a two step process. The first step being practiced at a first location, while the second step is practiced at a second location different from the first location. As used herein throughout, the phrase separate location means that the steps are physically separated. Such physical separation can be different locations within a single facility or in separate facilities. In either case, movement of the magnetic composition from the first location to the second location must take place.

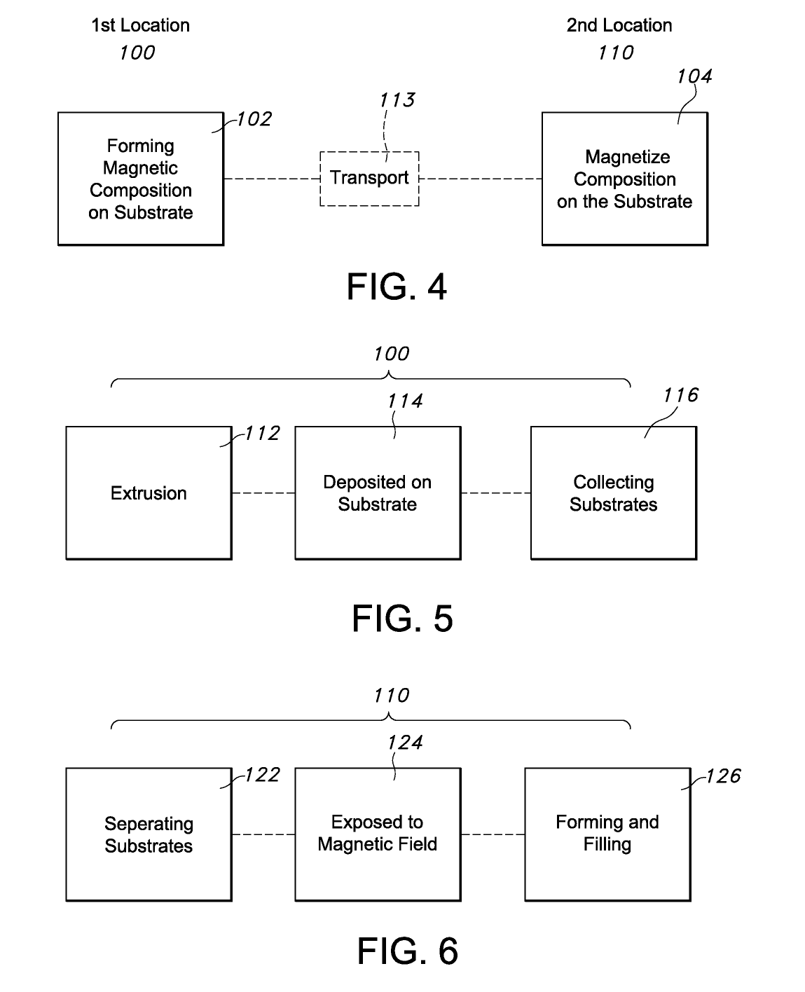

As shown in FIG. 4, at a first location 100, the forming 102 of the magnetic composition on a substrate takes place. Once the magnetic composition is formed, the magnetic composition may be magnetized 104 at the second location 110.

Referring now to FIG. 5, further details of the operation at the first location is shown. Preferably, magnetic composition is extruded 112. Thereafter, the extruded magnetic composition can be deposited 114 onto a substrate such as a packaging substrate. In a more preferred embodiment, the extrusion can be such that the magnetic composition is extruded directly onto the packaging substrate. Thereafter, at the first location, the plurality of packaging blanks which include the substrates having the magnetic composition thereon are collected 116. A wide variety of collection practices can be used, such as stacking or bundling the packaging substrates which include the magnetic composition. It is even contemplated that a continuous plurality of magnetic compositions on the substrate can be collected in a roll.

The present invention contemplates collecting the substrates, including the magnetic composition, before they are magnetized sufficiently to serve as functional reopenable magnetic closures. In this manner, the collection of the substrates of the magnetic composition, whether by stacking, rolling or other collection techniques will be such that there will be insufficient magnetic interaction between the packaging substrates to misalign the collected packaging substrates. By providing, insufficient magnetic strength to the substrates, they can be easily collected and transported 113 (FIG. 4) from the first location to the second location.

Referring now to FIG. 6, the operation at the second location 110 is shown. Upon receiving the collected substrates, the substrates are separated 122. Such separation could be by unstacking the substrates when they are stacked or by unrolling and cutting the substrates if they are rolled. The fact that the magnetic composition on the substrate is not sufficiently magnetized at this stage to cause magnetic interaction helps in handling the substrates at the second location. Thereafter, the individual substrates containing the magnetic composition can be exposed 124 to a magnetic field which magnetizes the composition on the substrates. Thereafter, the substrates, including the magnetized composition thereon, can be formed into a package housing and filled 126 with confectionery product, such as gum slabs or sticks, and form, for example, the closures shown in FIGS. 1 and 2.

Various changes to the foregoing described and shown structures would now be evident to those skilled in the art. Accordingly, the particularly disclosed scope of the invention is set forth in the following claims

What is claimed is:

1. A method of making a magnetic structure comprising:
forming a composition of magnetizable ferrites in a carrier on a substrate at a first location; and
magnetizing said composition on said substrate at a second location different from said first location.

2. A method of claim 1 further including the step of:
transporting said substrate with said composition from said first location to said second location.

3. A method of claim 2, further including, prior to said transporting step, collecting a plurality of said substrates with said composition.

4. A method of claim 3 wherein said forming step includes:
depositing said composition on a packaging substrate.

5. A method of claim 4 wherein said depositing step includes:
extruding said composition onto said package substrate.

6. A method of claim 4 wherein said collecting step includes:
stacking said plurality of said packaging substrates containing said composition without effecting sufficient magnetic interaction between said packaging substrates to misalign said stacked packaging substrates.

7. A method of claim 6 wherein said transporting step includes:
transporting said stacked packaging substrates.

8. A method of claim 7 further including, prior to said magnetizing step, the step of:
separating said packaging substrates at said second location.

9. A method of claim 8 wherein said magnetizing step includes:
exposing said unstacked packaging substrates to a magnetizing roller.

10. A method of forming a package for consumable products, said package having a magnetic closure comprising the steps of:
depositing at a first location a magnetizable composition on a packaging substrate, said magnetic composition includes magnetizable ferrites in a carrier;
at a second location, different from the first location:
magnetizing said composition on substrate;
forming said substrate into a package housing; and
filling said package with said consumable products.

11. A method of claim 10 wherein said depositing step includes:
extruding said composition onto said packaging substrate.

12. A method of claim 10 further including:
transporting a plurality of said packaging substrates including said magnetizable composition from said first location to said second location.

13. A method of claim 12 wherein said transporting step further includes:
stacking said packaging substrates including said magnetizable composition at said first location, without effecting sufficient magnetic interaction between said stacked substrates to cause misalignment.

14. A method of claim 13 wherein said magnetizing step includes:
exposing said packaging substrates at said second location to a magnetic field.

15. A method of claim 14 wherein said forming step and said filling step are practiced after said exposing step.

16. A method of claim 10 wherein said consumable products are selected from the group consisting of gum slabs and gum sticks.
